(19) United States
(12) Patent Application Publication
(10) Pub. No.: US 2025/0190745 A1
(43) Pub. Date: Jun. 12, 2025

(54) CAUSALITY REASONING

(71) Applicant: INTERNATIONAL BUSINESS MACHINES CORPORATION, ARMONK, NY (US)

(72) Inventor: Naoto Sato, Yokohama (JP)

(21) Appl. No.: 18/537,772

(22) Filed: Dec. 12, 2023

(51) Int. Cl. G06N 3/04

(52) U.S. Cl. CPC G06N 3/04

(57) ABSTRACT

A computer product and methodology is provided for causality reasoning. The computerized method includes determining that a lattice has a first plurality of elements, wherein each element includes at least one pair of cause events and an effect event, and the lattice is configured to relate each one of the first plurality of elements to at least one other element of the first plurality of elements based on the pair of cause events. The method further includes extending the lattice to include a second plurality of events. The method further includes determining a first effect event included in the second plurality of events and corresponding to a first pair of cause events included in the first plurality of elements.

### BACKGROUND

### Technical Field

The present disclosure generally relates to causal reasoning, and more particularly but not by way of limitation, to accurately approximating causality from entailed events.

### Description of the Related Art

Determination of causal relations is useful in many contexts, and can become more challenging as the amount of data collected increases. Such determinations can be resource intensive and may entail manual analysis to accurately detect relationships between causes and effects that are not readily discernable.

### SUMMARY

According to an embodiment of the present disclosure, a computer-implemented method is provided for causality reasoning. The method includes determining that a lattice has a first plurality of elements. Each element includes at least one pair of cause events and an effect event. The lattice is configured to relate each one of the first plurality of elements to at least one other element of the first plurality of elements based on the pair of cause events. The lattice is extended to include a second plurality of events. A first effect event included in the second plurality of events and corresponding to a first pair of cause events included in the first plurality of elements is determined.

In one embodiment, which may be combined with the preceding embodiment, a computer program product is provided for causality reasoning. The computer program product includes a computer readable storage medium having program instructions embodied therewith. An execution of the program instructions by a processor causes a computing device to determine a lattice has a first plurality of elements, wherein each element includes at least one pair of cause events and an effect event, and the lattice is configured to relate each one of the first plurality of elements to at least one other element of the first plurality of elements based on the pair of cause events. The computing device further extends the lattice to include a second plurality of events. The computing device further determines a first effect event included in the second plurality of events and corresponding to a first pair of cause events included in the first plurality of elements.

In one embodiment, a computer system is provided for causality reasoning. The computer system includes a processor, a computer-readable memory, a computer-readable tangible storage device, and program instructions stored on the computer-readable storage device for execution by a processor via the computer-readable memory. The computer system is configured to determine a lattice has a first plurality of elements, wherein each element includes at least one pair of cause events and an effect event, and the lattice is configured to relate each one of the first plurality of elements to at least one other element of the first plurality of elements based on the pair of cause events. The computer system is further configured to extend the lattice to include a second plurality of events. The computer system is further configured to determine a first effect event included in the second plurality of events and corresponding to a first pair of cause events included in the first plurality of elements.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a functional block diagram of a computer hardware platform for efficient and reliable causal reasoning, consistent with illustrative embodiments.

FIG. 2 tabulates a sample dataset, consistent with illustrative embodiments.

FIG. 3 tabulates predicted counterfactual values of the sample dataset in FIG. 2 by linear regression, consistent with illustrative embodiments.

FIG. 4 schematically depicts a lattice, consistent with illustrative embodiments.

FIG. 5 depicts solid-line connections mapping the sample dataset in FIG. 2 into a partially ordered set of data (“poset”), and broken-line connections mapping the poset to salary, consistent with illustrative embodiments.

FIG. 6 diagrammatically depicts a lattice having a plurality of elements, each element including at least one pair of cause events and an effect event, consistent with illustrative embodiments.

FIG. 7 diagrammatically depicts reordering a cause event in one of the elements to corresponding with the pair of cause events in the other element, consistent with illustrative embodiments.

FIG. 8 depicts extending the lattice in FIG. 6 according to a predefined template as join-homomorphism on the poset in FIG. 5, consistent with illustrative embodiments.

FIG. 9 depicts reducing the template in FIG. 8, consistent with illustrative embodiments.

FIG. 10 diagrammatically depicts extending the poset in FIG. 5 to add a hypothetical node, consistent with illustrative embodiments.

FIG. 11 diagrammatically depicts extending the poset in FIG. 5 to add a channel for the ED(0) domain in the sample calculations, consistent with illustrative embodiments.

FIG. 12 diagrammatically depicts extending the poset in FIG. 5 to add a channel for the ED(1) domain in the sample calculations, consistent with illustrative embodiments.

FIG. 13 diagrammatically depicts extending the poset in FIG. 5 to add a channel for the ED(2) domain in the sample calculations, consistent with illustrative embodiments.

FIG. 14 is a flowchart depicting steps in a method for causality reasoning, consistent with illustrative embodiments.

FIG. 15 tabulates predicted counterfactual values of the sample dataset in FIG. 2 by causality reasoning of the present disclosure, consistent with illustrative embodiments.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

According to an aspect of the present disclosure, there is provided a computer-implemented method for causal reasoning. The computer-implemented method includes reliably and consistently approximating causality from entailed events.

Machine learning (“ML”), and more generally artificial intelligence (“AI”), involves the development and use of computing systems that are configured to learn from data without need of explicit programming instructions. This science employs algorithms and statistics to analyze and inference from data values and patterns. ML constructs mathematical models (“ML models”) that can make predictions about current and future events based on training data obtained from historical events.

ML techniques generally fall into the categories of supervised learning, unsupervised learning, and reinforcement learning. Supervised learning aims to learn an input-output mapping function from a labeled dataset. Supervised learning can be grouped into classification models, regression models, and instance models.

Classification modeling refers to determining the classes (or categories) to which various data outputs belong. Classification can be employed when the outputs are restricted to a limited set of quantifiable values. Labels are assigned to the output values, and ML models are trained to predict the most probable output label from training data. Classification models can include, for example, linear classifiers, k-nearest neighbor (kNN), decision trees, random forests, support vector machines (SVMs), Bayesian classifiers, and convolutional neural networks.

Regression modeling (regression analysis) generally refers to estimating relationships between a dependent variable and one or more independent variables (“predictors” or “covariates” or “features”). In contrast to classification, regression does not have a discrete range of output values. Regression models can include, for example, logistic regression, linear regression, gradient descent (GD), and stochastic GD (SGD).

Instance modeling generally compares new feature values with historical feature values used in training and stored in memory. Instance models can include, for example, k-nearest neighbor, decision tree algorithms such as classification and regression tree (CART), iterative dichotomiser 3 (ID3), chi-square automatic interaction detection (CHAID), fuzzy decision tree (FDT), support vector machines (SVM), Bayesian algorithms, ensemble algorithms such as extreme gradient boosting, and random forest.

An ML “feature” is a measurable value of the system or process being analyzed via ML modeling. Features can be represented, for example, by integers, strings, variables, ordinals, real-values, and categories. A new feature can be derived from existing features. A set of features can form a “feature vector” tuple of one or more values called scalars. The vector space associated with these vectors is often called a “feature space.”

Unsupervised learning aims to map a function to hidden relationships by building an ML model from a dataset including only inputs without output labels. Unsupervised learning models can find relational patterns from groupings and clusterings of data. Some examples of unsupervised learning are K-means clustering, principal component analysis (PCA), and topic modeling.

Reinforcement learning aims to optimize a long-term objective by interacting with the environment based on a trial-and-error process. RL models can include, for example, Markov decision process, Markov chain, Q-learning, multi-armed bandit learning, and deep RL.

An artificial neural network is an ML modeling platform that can have a lattice arrangement of connected computing nodes. The nodes can transmit signals to other nodes. The nodes and the interconnections can be assigned individual weights, and those weights typically are adjusted during the learning process. Nodes can be configured with a threshold such that a signal is forwarded only if the upstream aggregate signal crosses the threshold. The nodes can be aggregated into layers, such that different layers perform different transformations. Signals travel from a first layer (input layer) to a last layer (output layer), by traversing hidden layers therebetween. The lattice can incorporated into different kinds of networks including, for example, deep neural (DNN), feed forward (FNN), convolutional (CNN), deep CNN (DCN), deconvolutional (DNN), recurrent (RNN), and deep stacking network (DSN).

Machine learning can include any or all the following aspects: 1) obtaining and preprocessing a dataset; 2) selecting features; 3) selecting an ML model; 4) dividing a dataset into training data and testing data; 5) training the ML model; 6) testing the ML model; and 7) optimizing (tuning) the ML model.

ML models employ model parameters and hyperparameters. Model parameters include values, characteristics and properties that are learned during training. In other words, a model parameter can be estimated from the training dataset. Model parameters are used in computations, and their values reflect accuracy with which the ML model makes predictions. Model parameters can include, for example, weights in a neural network, support vectors in a support vector machine, and coefficients in a logistic regression. Model parameters for classification modeling can include, for example, pixelation, word frequency, and character matching.

Hyperparameters cannot be learned during the training process, instead they are selected before training the ML model. They generally determine how training datasets are configured. Hyperparameters can include, for example, sample size, shuffling, number of training iterations (epochs), learning rate (convergence rate), hidden layer arrangements, weight initializations, dropout threshold, and gradient clipping threshold.

So, the term “machine learning” broadly describes a function of an electronic system that learns from data. A machine learning system, engine, or module can include using sampling datasets to run training trials on a trainable machine learning algorithm to learn functional relationships between inputs and outputs that are currently unknown.

Machine learning can be utilized to solve a variety of technical issues (e.g., learning previously unknown functional relationships) in connection with technologies such as, but not limited to, machine learning technologies, time-series data technologies, data analysis technologies, data classification technologies, data clustering technologies, trajectory/journey analysis technologies, medical device technologies, collaborative filtering technologies, recommendation system technologies, signal processing technologies, word embedding technologies, topic model technologies, image processing technologies, video processing technologies, audio processing technologies, and/or other digital technologies.

To better understand the features of the present disclosure, it may be helpful to discuss known architectures. To that end, the following detailed description illustrates various aspects of the present disclosure by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

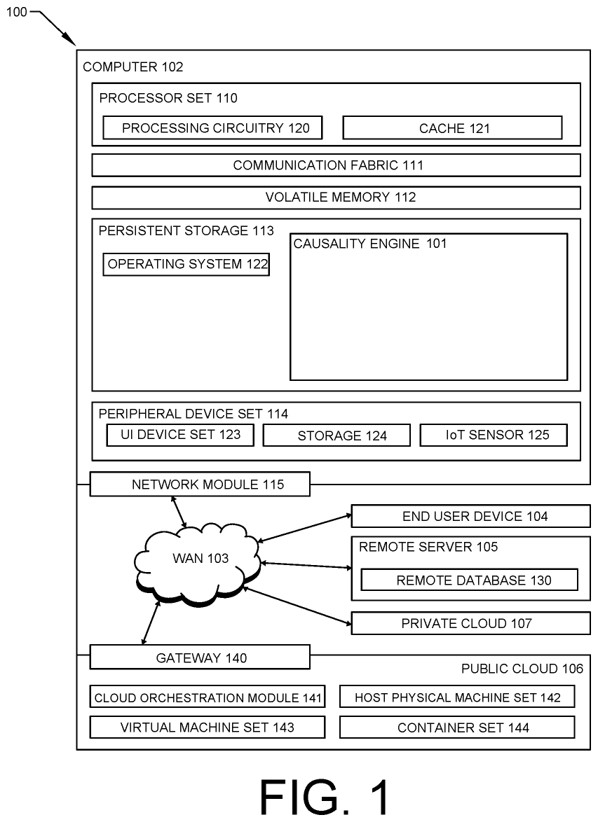

Referring to FIG. 1, computing environment 100 includes an example of an environment for the execution of at least some of the computer code involved in performing the inventive methods, including a causality engine (or block) 101. In addition to block 101, computing environment 100 includes, for example, computer 102, wide area network (WAN) 103, end user device (EUD) 104, remote server 105, public cloud 106, and private cloud 107. In this embodiment, computer 102 includes processor set 110 (including processing circuitry 120 and cache 121), communication fabric 111, volatile memory 112, persistent storage 113 (including operating system 122 and block 101, as identified above), peripheral device set 114 (including user interface (UI) device set 123, storage 124, and Internet of Things (IoT) sensor set 125), and network module 115. Remote server 105 includes remote database 130. Public cloud 106 includes gateway 140, cloud orchestration module 141, host physical machine set 142, virtual machine set 143, and container set 144.

COMPUTER 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 102 to cause a series of operational steps to be performed by processor set 110 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 101 in persistent storage 113.

COMMUNICATION FABRIC 111 is the signal conduction path that allows the various components of computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 102, the volatile memory 112 is located in a single package and is internal to computer 102, but, alternatively or additionally, the volatile memory may be distributed over multiple packages and/or located externally with respect to computer 102.

PERSISTENT STORAGE 113 is any form of non-volatile storage for computers that is now known or to be developed in the future. The non-volatility of this storage means that the stored data is maintained regardless of whether power is being supplied to computer 102 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 101 typically includes at least some of the computer code involved in performing the inventive methods.

PERIPHERAL DEVICE SET 114 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 102 to communicate with other computers through WAN 103. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 102 from an external computer or external storage device through a network adapter card or network interface included in network module 115.

WAN 103 is any wide area network (for example, the internet) capable of communicating computer data over non-local distances by any technology for communicating computer data, now known or to be developed in the future. In some embodiments, the WAN 103 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 104 is any computer system that is used and controlled by an end user (for example, a customer of an enterprise that operates computer 102), and may take any of the forms discussed above in connection with computer 102. EUD 104 typically receives helpful and useful data from the operations of computer 102. For example, in a hypothetical case where computer 102 is designed to provide a recommendation to an end user, this recommendation would typically be communicated from network module 115 of computer 102 through WAN 103 to EUD 104. In this way, EUD 104 can display, or otherwise present, the recommendation to an end user. In some embodiments, EUD 104 may be a client device, such as thin client, heavy client, mainframe computer, desktop computer and so on.

REMOTE SERVER 105 is any computer system that serves at least some data and/or functionality to computer 102. Remote server 105 may be controlled and used by the same entity that operates computer 102. Remote server 105 represents the machine(s) that collect and store helpful and useful data for use by other computers, such as computer 102. For example, in a hypothetical case where computer 102 is designed and programmed to provide a recommendation based on historical data, then this historical data may be provided to computer 102 from remote database 130 of remote server 105.

PUBLIC CLOUD 106 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 106 is performed by the computer hardware and/or software of cloud orchestration module 141. The computing resources provided by public cloud 106 are typically implemented by virtual computing environments that run on various computers making up the computers of host physical machine set 142, which is the universe of physical computers in and/or available to public cloud 106. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 106 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 107 is similar to public cloud 106, except that the computing resources are only available for use by a single enterprise. While private cloud 107 is depicted as being in communication with WAN 103, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 106 and private cloud 107 are both part of a larger hybrid cloud.

The computer 102 in some embodiments can be a computer server. The remote server 105 in some embodiments can represent multiple servers, which can provide machine learning resources and/or computer memory resources for the computer 102 and the causality engine 101 (see FIG. 1).

Accordingly, the computer 102 has a specialized processing unit such as the causality engine 101 and the like for carrying out computations related to causality reasoning. More particularly, without limitation, the specialized processing unit automatically and consistently approximates causality in entailed events. The computer system is thereby specifically configured to provide technical improvements to data systems, machine learning systems, artificial intelligence systems, and systems of data analysis systems such as but not limited to data classification systems, data regression systems, data batching and clustering systems, and the like. The optimization can further provide one or more inferences, provide one or more predictions, and/or determine one or more relationships among the data. For example, optimization as described herein can model one or more inferences and/or predictions and/or may determine one or more relationships amongst the variables analyzed in the data. Machine learning predicts outputs, e.g., probabilities, from historical data. Such optimized machine learning helps with downstream decision making, even with such downstream decision making that is automated.

The optimization resources can employ any suitable ML based techniques, statistical-based techniques and/or probabilistic-based techniques. For example, the ML resources can employ expert systems, fuzzy logic, SVMs, Hidden Markov Models (HMMs), greedy search algorithms, rule-based systems, Bayesian models (e.g., Bayesian networks), neural networks, other non-linear training techniques, data fusion, utility-based analytical systems, and the like. For example, the ML resources can perform a set of clustering ML computations, a set of logistic regression ML computations, a set of decision tree ML computations, a set of random forest ML computations, a set of regression tree ML computations, a set of least square ML computations, a set of instance-based ML computations, a set of support vector regression ML computations, a set of k-means ML computations, a set of spectral clustering ML computations, Gaussian mixture model ML computations, a set of regularization ML computations, a set of rule ML computations, a set of Bayesian ML computations, a set of deep Boltzmann computations, a set of deep belief network computations, a set of convolution neural network computations, a set of stacked auto-encoder computations and/or a set of different ML computations.

Accordingly, the computing system generally facilitates causal reasoning in accordance with one or more embodiments illustratively described herein. For example, the optimizations can be related to artificial neural network systems, an artificial intelligence system, a collaborative filtering system, a recommendation system, a signal processing system, a word embedding system, a topic model system, an image processing system, a data analysis system, a media content system, a video-streaming service system, an audio-streaming service system, an e-commerce system, a social network system, an internet search system, an online advertisement system, a medical system, an industrial system, a manufacturing system, and/or another digital system. The system can employ hardware and/or software to solve problems that are highly technical in nature, that are not abstract and that cannot be performed as a set of mental acts by a human.

For simplicity of explanation, the specialized-computer-implemented methods are depicted and described as a series of acts. It is to be understood and appreciated that the subject innovation is not limited by the acts illustrated and/or by the order of acts. That is, for example, acts can occur in various orders and/or concurrently, and with other acts not presented and described herein. Furthermore, not all expressly disclosed acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from a computer-readable device or storage media.

The system can employ hardware and/or software to solve problems that are highly technical in nature, that are not abstract and that cannot be performed as a set of mental acts by a human. One or more embodiments of the system can also provide technical improvements to a computer processing unit associated with a ML process by improving processing performance of the computer processing unit, reducing computing bottlenecks of the computer processing unit, improving processing efficiency of the computer processing unit, and/or reducing an amount of time for the computer processing unit to perform the ML process.

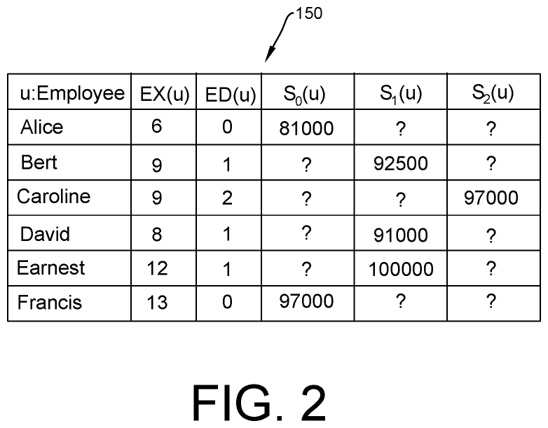

In the following disclosure of illustrative embodiments, FIG. 2 tabulates sample data for each of a number of employees (uᵢ). The sampled features include experience EX(uᵢ), education ED(uᵢ), and salary S(uᵢ). For purposes of this example, EX(uᵢ) and ED(uᵢ) are independent features and S(uᵢ) is a dependent feature. The values for EX(uᵢ) represent years of employment. ED(uᵢ) is a code value of either “0”= high school, or “1”= college, or “2”= graduate school. The sample data includes only one salary value for each employee, corresponding to the respective experience and education. Question marks “?” denote a counterfactual data subset (or “counterfactual domain”) of the other unsampled, and thereby unavailable, salary values.

One way of predicting the counterfactual values can be performing linear regression on the sample data. Doing so can model the sampled features according to the following mathematical relationship:

$$S = 65000 + 2 \; 500 EX + 5 \; 000 ED$$

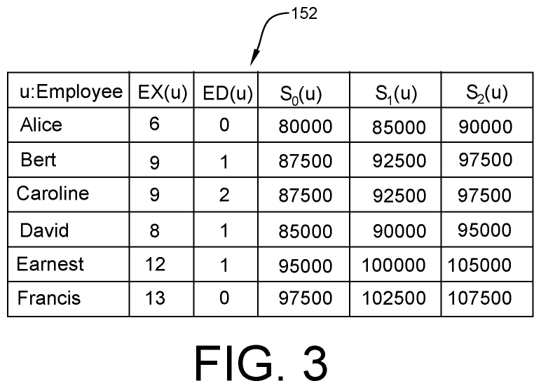

FIG. 3 depicts the predicted values that are obtained by linear regression.

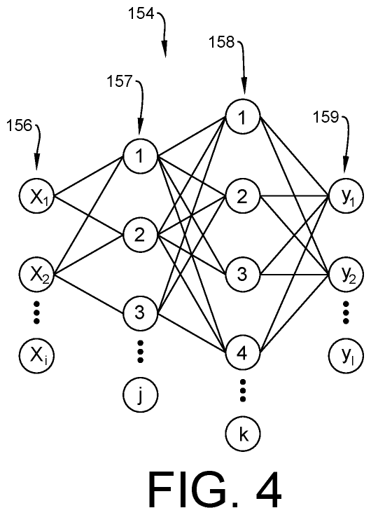

Another way of predicting the counterfactual values can be by performing machine learning, utilizing one or more of a wide variety of different machine learning models. One such machine learning model having a lattice 154 is schematically depicted in FIG. 4. The lattice 154 has an input layer 156 with any number of nodes (x₁, x₂, . . . Xᵢ) that can represent input data to the lattice. In this example, the input nodes can correspond to a feature set, such an employee and his/her corresponding experience and education. An output layer 159 likewise has any number of nodes (y₁, y₂, . . . y₁) can represent the predictions made by the lattice 154. The number of nodes in the output layer 159 can be related to the number of desired outputs for a given set of inputs. In a regression, for example, there can be only one node in the output layer 159 for the expected single output value. However, in classification modeling there can be a number of nodes, one for each classification. In this example, the output nodes can correspond to predicted salary values, S(0), S(1) and S(2). Hidden layers 157, 158 are connected to the input layer 156 and the output layer 159, and interconnected between themselves. Generally, the number of layers and the numbers of nodes in each layer determines modeling accuracy, but also determines computational overhead cost.

The nodes apply bias parameters that the lattice 154 learns and adjusts during a training process. These bias parameters can be initialized, even randomly, and then the lattice 154 adjusts (or tunes) them to minimize a computed loss function. The connections (or edges) similarly apply weight parameters corresponding to relative importance of the connection. Like the bias parameters, the weight parameters can begin as initialized values that are subsequently optimized by iteratively learning over training trials. An activation function transforms the weighted inputs from an upstream node and selectively activates a downstream node. The activation function extracts complex patterns present in the data. Widely used activation functions include Sigmoid, ReLU, and Softmax. The loss function adjusts these parametric values to minimize differences between predicted outputs and expected outputs of the lattice 154.

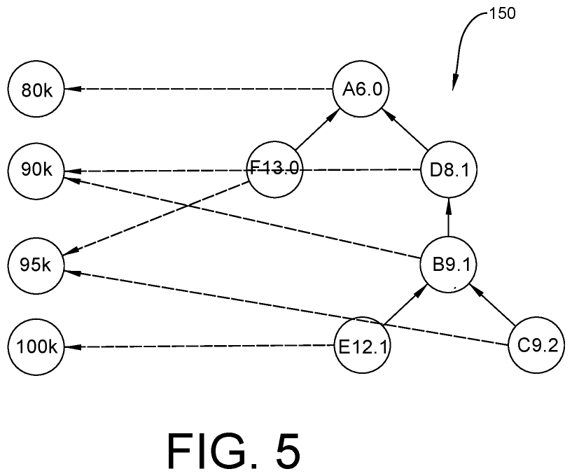

FIG. 5 depicts arranging the sample data into a partially ordered set of data (“poset”) 150 according to the experience, education and salary features in this example. The solid-line connectors map the poset 150 according to experience and education features. “A6.0” for example, represents the data corresponding to Alice with six years of employment and a high school education. The broken-line connectors map the poset 150 to a salary scale. This ordering puts Alice at one end of the lattice at the low end of the salary scale, and puts Earnest with twelve years of employment and a college education at the other end of the lattice at the high end of the salary scale.

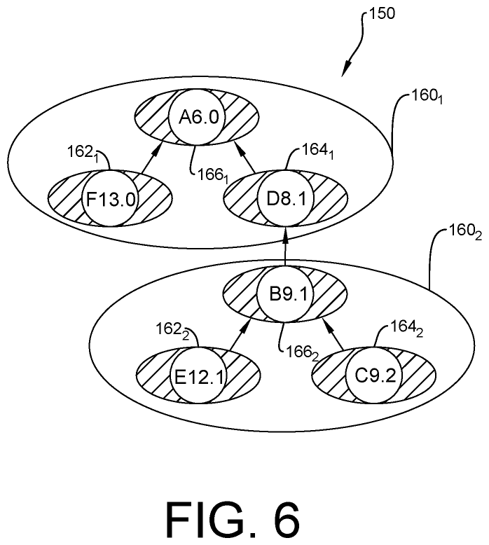

FIG. 6 further annotates the nodes in FIG. 5 with a hatching pattern representing each node's membership in the poset 150. The causality engine 101 is configured to identify the mapped arrangement of the poset 150. For example, the causality engine 101 is configured to classify the poset 150 lattice in terms of it having a plurality of elements 160₁, 160₂. Each element 160₁, 160₂ includes at least one pair of cause events 162, 164 and an effect event 166. In this lattice configuration, each of the two elements 160 can relate to the other element 160 based on the paired cause events 162, 164.

The causality engine 101 is further configured to reorder the poset 150 in response to identifying certain predefined lattice configurations. The lattice configuration in FIG. 6 illustrates one such predefined lattice configuration, which can be reordered to approximate causality from events that are ordered by entailment.

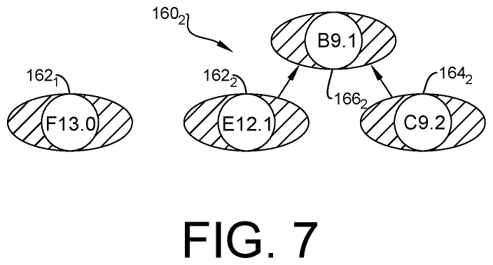

FIG. 7 depicts an example of this by reordering the cause event 162₁ in FIG. 6 to correspond with the second element 160₂. When both the cause event 162₂ and the cause event 164₂ occur, then the effect event 166₂ occurs, selectively, such as according to the activation function and parameterization of the nodes and links. That is, the pair of cause events (“Cᵢ”) 162₂, 164₂ expressly correspond to the effect event (“E;”) 166₂.

$$( C\_ ( 162 ( 2 ) ) ⋂ C\_ ( 164 ( 2 ) ) ) cause / \to E\_ ( 166 ( 2 ) )$$

Which can be symbolized as:

$$( C {162 ( 2 )}_{} ⋂ {C}_{164 ( 2 )} ) {C}_{} {E}_{166 ( 2 )}$$

Beyond the machine learning that comes from that express causal relationship, there exists the possibility to learn from any non-expressed causality by corresponding the second element 160₂ (FIG. 6) with the cause event C₁₆₂₍₁₎. The question arises, would that extend causality?

$$If ( C {162 ( 2 )}_{} ⋂ {C}_{164 ( 2 )} ) {C}_{} {E}_{166 ( 2 )} , then ( C {162 ( 1 )}_{} ⋂ {C}_{164 ( 2 )} ) {C}_{} {E}_{166 ( 2 )} ?$$

An accurate approximation can be based on incorporating entailment into causality reasoning.

$$If \frac{( C {162 ( 2 )}_{} ) entail}{\to ( {C}_{162 ( 1 )} )} , then ( C {162 ( 1 )}_{} ⋂ {C}_{164 ( 2 )} ) \frac{entail}{\to } {E}_{166 ( 2 )}$$

This causal reasoning approximation can be represented as:

$$( C {162 ( 1 )}_{} ⋂ {C}_{164 ( 2 )} ) {E}_{166 ( 2 )}$$

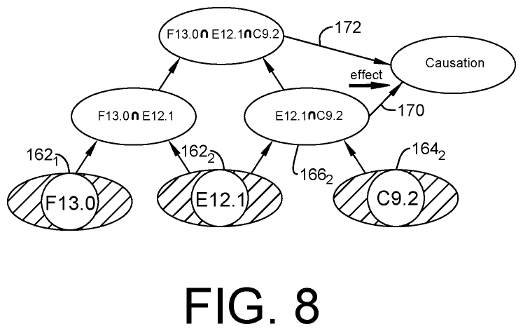

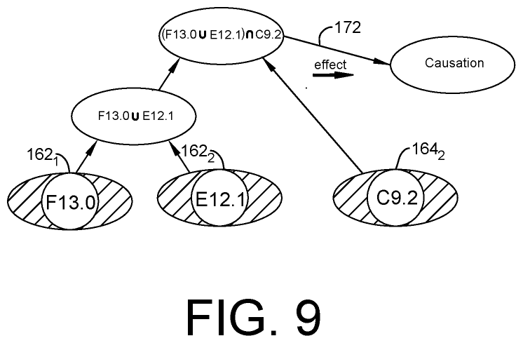

A way to derive this approximation can be to store a template in computer memory with which to map a logical extension of the second element 160₂ to include C₁₆₂₍₁₎. FIG. 8 depicts what an illustrative template could map. It depicts both the express causation 170 and the non-express causation 172 such as that arising from entailment. FIG. 9 depicts how this mapping can be homomorphically reduced.

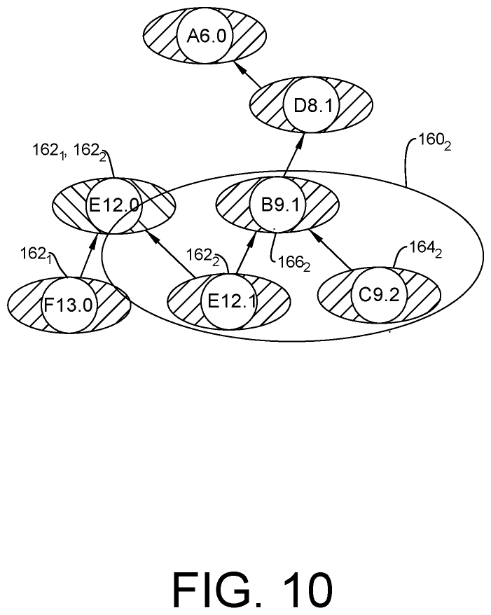

Thus, expanding a lattice by a template as join-homomorphism on the poset 150 can provide an accurate basis for approximating causality. FIG. 10 depicts mapping a hypothetical counterfactual node corresponding to events (F13.0 U E12.1) 162₁, 162₂ to the second element 160₂. In this example, the counterfactual node can be mapped as the nearest neighbor of event F13.0 and event E12.1. In this example, that maps the counterfactual node at event E12.0. The nonfactual node at event E12.0 is hatched differently to aid in distinguishing it from the poset 150.

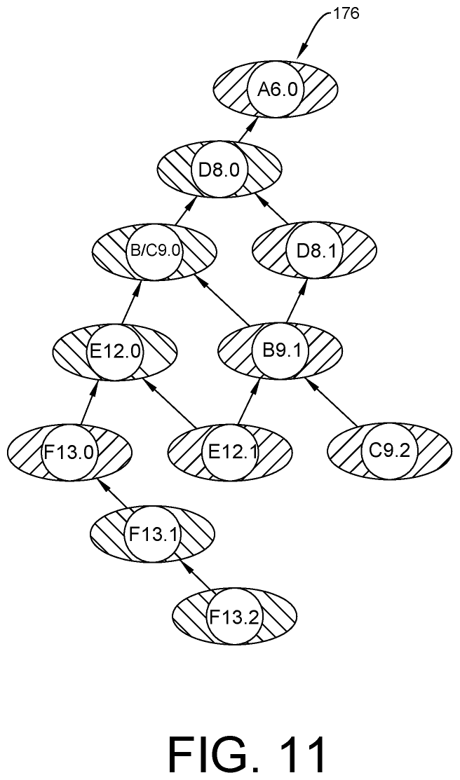

FIG. 11 depicts the reordered poset 150 can be further be expanded by adding nonfactual nodes at event B/C9.0 (B9.0 =C9.0) and at event D8.0. This orders a hypothetical channel 176 in the lattice for the education=“0” (ED(0)) feature domain. This ED(0) channel can be further extended below event E12.0 by mapping more nonfactual nodes at event E13.0, event E13.1, and event F13.2. The new nonfactual nodes at event B/C9.0 and at event D8.0 can be paired with events in the poset 150 to form employee cross channels in the lattice.

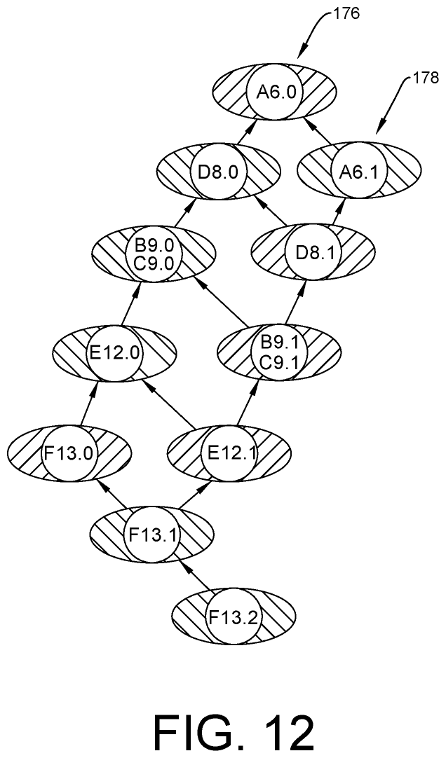

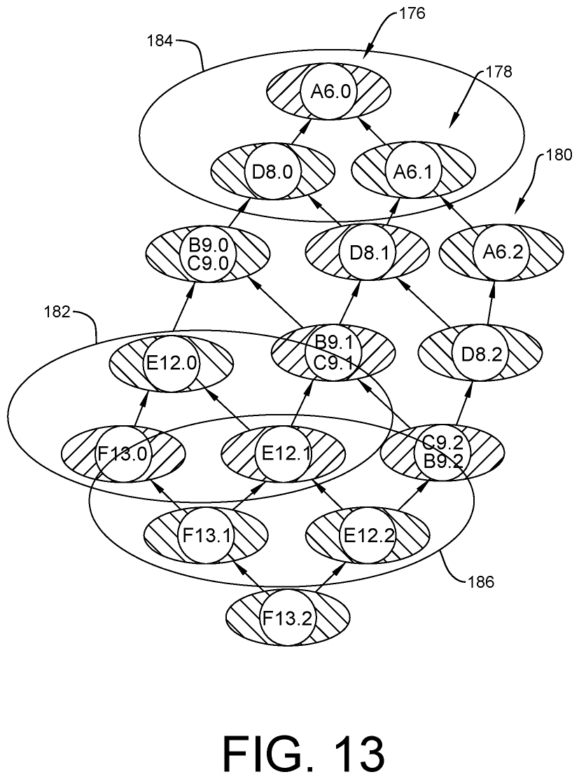

FIG. 12 depicts further expansion of the poset 150 by pairing event F13.1 with event E12.1, and by mapping another nonfactual node at event A6.1, to form a channel 178 in the lattice throughout the ED(1) domain. Similarly, FIG. 13 depicts mapping more nonfactual nodes at event E12.2, event B/C9.2, event D8.2, and event A6.2 to form a channel 180 in the lattice throughout the ED(2) domain. These new nonfactual nodes can be linked to the poset 150 to further extend the cross channels in the lattice throughout each individual employee domain.

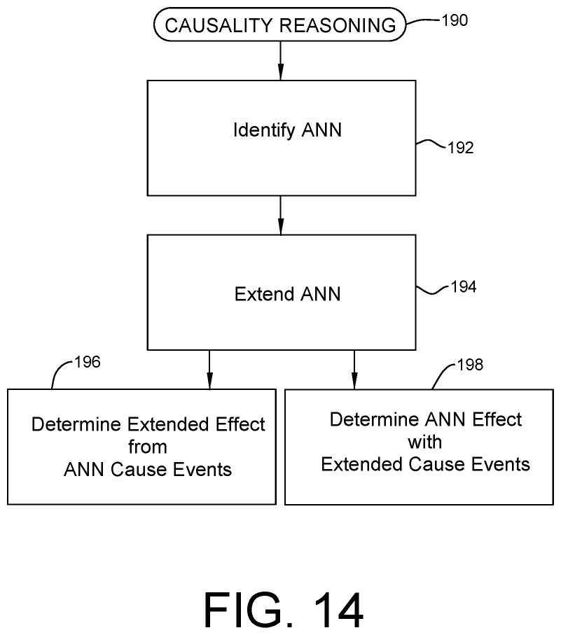

Generally summarizing the foregoing disclosure in terms of the illustrative embodiments, FIG. 14 is a flowchart depicting steps in a computerized method 190 for causality reasoning. In block 192, the computerized method includes determining that a lattice has a first plurality of elements, such as 160₁, 160₂ (FIG. 6). Each element 160₁, 160₂ can include at least one pair of cause events, such as 162ᵢ, 164ᵢ, and an effect event, such as 166ᵢ. The lattice can be configured to relate each one of the first plurality of elements (such as 160₁, 160₂) to at least one other element of the first plurality of elements based on a pair of cause events (such as 162ᵢ, 164ᵢ).

In block 194, the method extends the lattice to include a second plurality of events, such as depicted by the hatching differentiation in FIG. 13. In block 196 the computerized method determines an extended effect event, such as event E12.0, that corresponds to a first pair of cause events (such as event F13.0 and event E12.1) that are included in the lattice. This is denoted by reference number 182 in FIG. 13. In block 198, the computerized method determines an effect event included in the lattice, such as effect event A6.0, that corresponds to a first pair of extended cause events (such as cause event D8.0 and cause event A6.1). This is denoted by reference number 184 in FIG. 3. In some cases, the block 198 can determine a second effect event included in the lattice, such as effect event E12.1, that corresponds to a second pair of extended cause events (such as cause event F13.1 and cause event E12.2). This is denoted by reference number 186 in FIG. 13. The determinations in blocks 196, 198 can occur during a machine learning instance on the extended lattice, such as when training the extended lattice and when running machine learning trials on the extended lattice.

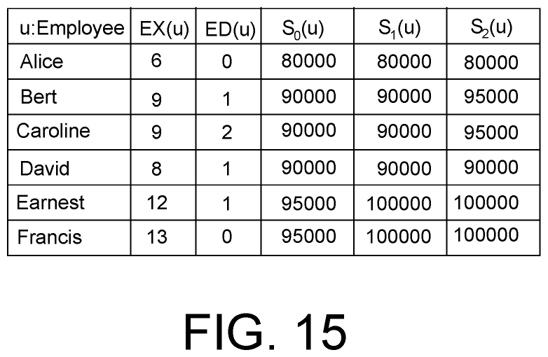

A comparison of the initial mapping in FIG. 6 to the extended mapping in FIG. 13 demonstrates a strategic approach for mapping the feature domain as a continuous function, such as according to a monotonic function, between posets that implies infinite combinations of causality pairs without definition. New hypothetical nodes define events ordered by entailment. Basing the extension on formulating a template as join-homomorphism on a factual, or even partially factual, poset can provide accurate approximation of causality. Note that in this illustrative extension the accurate approximations go so far as to determine the factual effect event A6.0 as newly corresponding to a second pair of hypothetical cause events, cause event D8.0 and cause event A6.1. The same is true for factual effect event E12.1 that newly corresponds to cause event F13.1 and cause event E12.2. FIG. 15 tabulates the predicted sample values according to the method of FIG. 14, consistent with illustrative embodiments.

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings. The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to call flow illustrations and/or block diagrams of a method, apparatus (systems), and computer program products according to embodiments of the present disclosure. It will be understood that each step of the flowchart illustrations and/or block diagrams, and combinations of blocks in the call flow illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the call flow process and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the call flow and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the call flow process and/or block diagram block or blocks.

The flowchart and block diagrams in the Figures illustrate the architecture, functionality, and operation of possible implementations of systems, methods, and computer program products according to various embodiments of the present disclosure. In this regard, each block in the call flow process or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or call flow illustration, and combinations of blocks in the block diagrams and/or call flow illustration, can be implemented by special purpose hardware-based systems that perform the specified functions or acts or carry out combinations of special purpose hardware and computer instructions.

It is to be appreciated that the computer system (e.g., the specialized computer 102, the causality engine 101, and/or the processing resources) performs acts in optimizing machine learning that cannot be performed by a human (e.g., is greater than the capability of a single human mind). For example, an amount of data processed, a speed of processing of data and/or data types of the data processed over a certain period of time can be greater, faster and different than an amount, speed and data type that can be processed by a single human mind over the same period of time. The computer system can also be fully operational towards performing one or more other functions while also performing the above-referenced hyperparameter optimization of an ML model. Moreover, ML output generated by computer system can include information that is impossible to obtain manually by a user. For example, an amount of information included in the ML output and/or a variety of information included in the ML output can be more complex than information obtained manually by a user.

Moreover, because at least machine learning optimization is established from a combination of electrical and mechanical components and circuitry, a human is unable to replicate or perform processing performed by the computer system (e.g., specialized computer 102, the causality engine 101, resources) disclosed herein. For example, a human is unable to communicate data and/or process data associated with the causality engine 101 for a given downstream task. Additionally, the specialized computer 102 significantly improves the operating efficiencies of the computer system by accurately approximating non-expressed causality during machine learning.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed:

1. A computer-implemented method for causality reasoning, comprising:
upon determining a lattice has a first plurality of elements, wherein:
each element includes at least one pair of cause events and an effect event; and
the lattice is configured to relate each one of the first plurality of elements to at least one other element of the first plurality of elements based on the pair of cause events;
extending the lattice to include a second plurality of events; and
determining a first effect event included in the second plurality of events and corresponding to a first pair of cause events included in the first plurality of elements.

2. The computer-implemented method of claim 1, further comprising determining a first effect event included in the first plurality of elements and corresponding to a first pair of cause events included in the second plurality of events.

3. The computer-implemented method of claim 2, further comprising determining a second effect event included in the first plurality of elements and corresponding to a second pair of cause events included in the second plurality of elements.

4. The computer-implemented method of claim 1 wherein the second plurality of elements comprises a counterfactual domain.

5. The computer-implemented method of claim 1, further comprising arranging the first plurality of elements into a first partial ordered set of data.

6. The computer-implemented method of claim 1, further comprising extending the lattice according to a continuous function.

7. The computer-implemented method of claim 5, further comprising extending the lattice according to a predefined template as join-homomorphism on the first partial ordered set of data.

8. The computer-implemented method of claim 1, wherein the first effect event in the second plurality of events corresponds to the pair of cause events in the first plurality of elements according to an approximation of causality.

9. The computer-implemented method of claim 8, wherein the first effect event in the second plurality of events corresponds to the pair of cause events in the first plurality of elements according to entailment.

10. A computer program product for causality reasoning, the computer program product comprising a computer readable storage medium having program instructions embodied therewith, wherein an execution of the program instructions by a computer processor causes a computing device to:
upon determining a lattice has a first plurality of elements, wherein:
each element includes at least one pair of cause events and an effect event; and
the lattice is configured to relate each one of the first plurality of elements to at least one other element of the first plurality of elements based on the pair of cause events;
extending the lattice to include a second plurality of events; and
determining a first effect event included in the second plurality of events and corresponding to a first pair of cause events included in the first plurality of elements.

11. The computer program product of claim 10, wherein the execution of the program instructions further causes the computing device to determine a first effect event included in the first plurality of elements and corresponding to a first pair of cause events included in the second plurality of events.

12. The computer program product of claim 11, wherein the execution of the program instructions further causes the computing device to determine a second effect event included in the first plurality of elements and corresponding to a second pair of cause events included in the second plurality of elements.

13. The computer program product of claim 10, wherein the execution of the program instructions further causes the computing device to form the second plurality of elements to comprise a counterfactual domain.

14. The computer program product of claim 10, wherein the execution of the program instructions further causes the computing device to arrange the first plurality of elements into a first partial ordered set of data.

15. The computer program product of claim 14, wherein the execution of the program instructions further causes the computing device to extend the lattice according to a predefined template as join-homomorphism on the first partial ordered set of data.

16. The computer program product of claim 10, wherein the execution of the program instructions further causes the computing device to extend the lattice according to a continuous function.

17. The computer program product of claim 16, wherein the execution of the program instructions further causes the computing device to extend the lattice according to a monotonic function.

18. The computer program product of claim 10, wherein the execution of the program instructions further causes the computing device to correspond the first effect event in the second plurality of events to the pair of cause events in the first plurality of elements according to an approximation of causality.

19. The computer program product of claim 18, wherein the execution of the program instructions further causes the computing device to correspond the first effect event in the second plurality of events to the pair of cause events in the first plurality of elements according to entailment.

20. A computer system for causality reasoning, the computer system having a processor, a computer-readable memory, a computer-readable tangible storage device, and program instructions stored on the computer-readable storage device for execution by a processor via the computer-readable memory, wherein the computer system is configured to perform a method, comprising:
upon determining a lattice has a first plurality of elements, wherein:
each element includes at least one pair of cause events and an effect event; and
the lattice is configured to relate each one of the first plurality of elements to at least one other element of the first plurality of elements based on the pair of cause events;
extending the lattice to include a second plurality of events; and
determining a first effect event included in the second plurality of events and corresponding to a first pair of cause events included in the first plurality of elements.
